(19) United States
(12) Patent Application Publication
(10) Pub. No.: US 2009/0222576 A1
(43) Pub. Date: Sep. 3, 2009

(54) METHOD AND APPARATUS FOR REDUCING POWER CONSUMPTION OF A NETWORK COMMUNICATION DEVICE RECEIVING STREAMING CONTENT VIA AN IP-BASED NETWORK

(75) Inventors: Erik Elstermann, Carlsbad, CA (US); Vinh Tran, Carlsbad, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/039,837

(22) Filed: Feb. 29, 2008

(51) Int. Cl. G06F 15/173; G06F 1/00

(52) U.S. Cl. 709/238; 713/323

(57) ABSTRACT

A method and apparatus for transmitting multimedia content to a network communication device, such as a wireless local area network (WLAN) device, via one or more IP-based networks, in a manner that reduces power consumption by the network communication device. A system stream server, such as a set-top box, transmits content using a burst transmission mode. The transmitted content includes control information indicating the time of the next transmission burst, thus allowing the device to go into a sleep mode when the content stream is not being burst. Operation of the device in this manner reduces power consumption by the device. The stream server can switch dynamically between burst and non-burst transmission modes according to the needs of the network communication device. The IP-based network is bi-directional, thus the network communication device can communicate to the stream server the manner in which transmission bursts can be received by the device.

### BACKGROUND OF THE INVENTION

1. Field of the Invention

The invention relates to streaming content to network communication devices, such as wireless local area network (WLAN) devices, via Internet Protocol (IP) networks. More particularly, the invention relates to methods for streaming content to network communication devices via an IP-based network in a manner that reduces power consumption by the network communication devices.

2. Description of the Related Art

In conventional multimedia content distribution systems, multimedia content is transmitted from a multimedia content or service provider through a content delivery network to a stream server, such as a set-top box or other multimedia content processing device. The multimedia content typically is stored by the stream server, and subsequently forwarded through a network, such as an Internet Protocol (IP)-based network, to one or more network communication devices, such as a wireless local area network (WLAN) device or other suitable network communication devices, including mobile communication devices. The stream server can transmit the multimedia content to the network in real-time or in non-real-time.

Digital Video Broadcasting—Handheld (DVB-H) generally refers to the set of technical specifications for broadcasting multimedia services, e.g., digital television content, to handheld terminals. The DVB-H specification ETSI EN 301 192 describes a method for time-slicing that is used in DVB-H networks to reduce the average power consumption of DVB-H terminal devices, i.e., the DVB-H devices receiving the broadcast multimedia content. The objective of time-slicing is to reduce the average power consumption of the terminal device and to enable smooth and seamless service handover. Time-slicing consists of sending data in bursts using a significantly higher instantaneous bit rate compared to the bit rate required if the data were transmitted using traditional streaming mechanisms.

However, within DVB-H networks, the multimedia content transport medium is an MPEG-2 based transport medium, and, as such, does not address the transmission or delivery of streaming multimedia content via IP-based networks to network communication devices, such as WLAN devices (including WLAN mobile communication devices) and other network communication devices, including network communication devices in accordance with one or more 802.11 WLAN communication specifications.

### BRIEF DESCRIPTION OF THE DRAWINGS

FIG. 1 is a block diagram of a system for transmitting multimedia content to a network communication device, such as a wireless local area network (WLAN) device, via an Internet Protocol (IP) based network;

FIG. 2 is a block diagram of a stream server device, such as a set-top box, configured for transmitting multimedia content, using a burst transmission mode, to a network communication device via an IP-based network;

FIG. 3 is a block diagram of a conventional, non-burst mode stream of multimedia content;

FIG. 4 is a block diagram of the output of a stream server device, such as a set-top box, configured to deliver multimedia content according to a burst transmission mode;

FIG. 5 is a block diagram of the multimedia content input to a network communication device, such as a WLAN device, according to a burst transmission mode; and

FIG. 6 is a block diagram of a method for transmitting multimedia content, using a burst transmission mode, to a network communication device, such as a WLAN device, via an IP-based IP network.

### DETAILED DESCRIPTION

In the following description, like reference numerals indicate like components to enhance the understanding of the content delivery methods through the description of the drawings. Also, although specific features, configurations and arrangements are discussed herein below, it should be understood that such specificity is for illustrative purposes only. A person skilled in the relevant art will recognize that other steps, configurations and arrangements are useful without departing from the spirit and scope of the invention.

The methods, devices and systems described herein involve transmitting or delivering multimedia content to network communication devices, such as wireless local area network (WLAN) devices and other mobile communication devices, via IP-based networks, including wireless IP-based networks, using a burst transmission mode. System stream servers, such as set-top boxes and other multimedia content processing devices, receive and store multimedia content from a content or service provider, and are configured to transmit multimedia content to IP-based network communication devices in a time-sliced manner to produce bursts of transmitted content, rather than a fixed, steady stream of content. The stream servers also are configured to advertise the time of the next transmission burst, thus allowing a network communication device to disable or cause portions of its circuitry to go into a sleep mode when the content stream is not being burst. Operation of the network communication device in this manner reduces power consumption by the device. Content transmission bursts by the stream servers can be periodic or aperiodic. Also, the stream servers can switch dynamically between burst and non-burst transmission modes according to the needs of the network communication device. The IP-based network, which is a bi-directional network, allows data traffic to be unicast by the stream server. Thus, each network communication device can receive a unique content stream from the stream server, and can communicate to the stream server the specific manner in which the transmission bursts can be received by the device, e.g., the frequency and/or bandwidth of the burst.

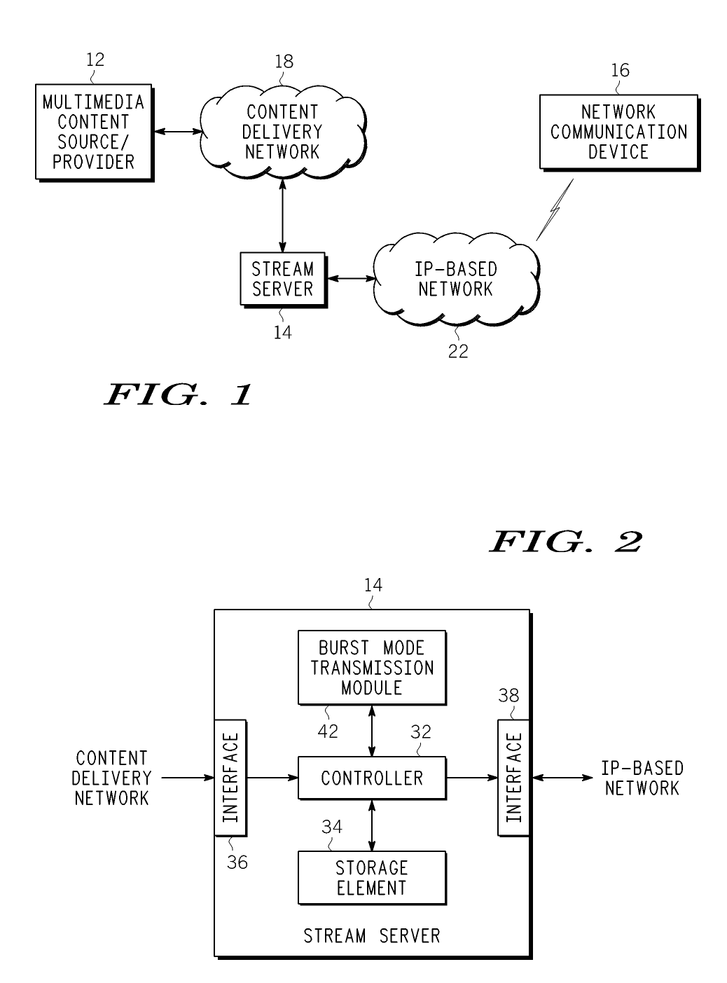

Referring to FIG. 1, shown is a block diagram of a system 10 for transmitting multimedia content to a network communication device, such as a wireless local area network (WLAN) device, using a burst transmission mode. The system 10 includes a multimedia content source or provider 12, a stream server 14 or other multimedia processing device, such as a set-top box, and a network communication device 16, such as a wireless local area network (WLAN) device. The stream server 14 is coupled to the multimedia content provider 12 via one or more content delivery networks 18, which can be or include one or more suitable IP-based networks for transmitting multimedia content to the stream server 14. Multimedia content received by the stream server 14 is stored in the stream server 14 and subsequently forwarded to the network communication device 16 via an IP-based network 22, which can be or include any network structure, including one or more wireless network control points, suitable for transmitting IP data packets to the network communication device 16.

The multimedia content source 12 can be any suitable transmission source of multimedia content, such as from a cable television plant, satellite service provider or other multimedia service provider. The multimedia content can be any suitable multimedia content, including Internet Protocol Television (IPTV) video content, which is considered to be any video or content delivered over the internet using IP protocols. Also, the multimedia content can include movies, programming events, music, photos and/or other multimedia content that is distributed, e.g., as one or more programming streams from a broadcast source or other suitable multimedia content source. The multimedia content typically is a plurality of digital signals formatted according to a suitable standard, such as the MPEG (Moving Picture Experts Group) 2 or MPEG 4 standard, and multiplexed into a data stream that is modulated on a carrier using quadrature amplitude modulation (QAM) or other suitable modulation technique.

The content delivery network 18 can be any communication network or network server arrangement suitable for coupling the multimedia content provider 12 directly or indirectly to the stream server 14. For example, all or a portion of the network 18 can be the Internet or an Internet protocol (IP) based network, a computer network, a web-based network or other suitable wired or wireless network system. Also, the multimedia content provider 12 and the stream server 14 can be coupled to the content delivery network 18 via any suitable connection or connections, e.g., one or more coaxial cables and/or optical fibers, including a Hybrid Fiber Coaxial (HFC) cable system. Other suitable connections include suitable Fiber To The Premises (FTTP) systems, such as Fiber To The Curb (FTTC) or Fiber To The Home (FTTH), or over any suitable number of digital subscriber line systems (xDSL). Also, the multimedia content can be provided wirelessly, e.g., via over-the-air-broadcast from a satellite service provider or other suitable multimedia content service provider 12.

The IP-based network 22 can be or include any IP network structure suitable for transmitting multimedia content to the network communication device 16 using Internet Protocol (IP). For example, the IP-based network 22 can include or be part of an IP-based mobile communications system known as the Fourth Generation (4G) wireless network. Also, all or a portion of the IP-based network 22 can be or include any wireless wide area network (WAN) or wireless local area network (WLAN). Also, the IP-based network 22 can be or include one or more wireless IP network control points. Multimedia content transmitted from the IP-based network 22 to the network communication device 16 typically is in the form of IP data packets or datagrams, and can be unicast to individual network communication devices rather than broadcast to all devices within the network, as in DVB-H networks. Also, unlike DVB-H networks and other broadcast networks, the IP-based network 22 can be a bi-directional communication network. Thus, as will be discussed in greater detail hereinbelow, information generated by the network communication device 16 can be transmitted to the IP-based network 22.

The stream server 14 can be any suitable multimedia content processing device. The stream server 14 can be partially or completely any suitable device or subsystem (or portion thereof) for receiving multimedia content from the multimedia content source 12, storing the received multimedia content (for later viewing), processing and/or decoding the received multimedia content, and transmitting or transferring the processed multimedia content to the IP-based network 22. For example, the stream server 14 can be any digital video recorder (DVR) or digital video server (DVS) device, including any signal converter or decoder (set-top) box with internal and/or external recording capabilities and local and/or remote storage, which often are referred to as personal video recorder (PVR) devices. Other suitable stream servers include a network session controller, a wireless network server, a residential gateway, a home media server system, a wireless home media server system, a digital video server, a computer, and/or other suitable computing devices or multimedia content devices, including internet protocol (IP), satellite and cable digital video recorders, and home area network (HAN) devices and systems. As will be discussed in greater detail hereinbelow, the stream server 14 is configured to transmit multimedia content to the IP-based network 22 in a burst transmission mode.

The network communication device 16 can be any suitable end user network communication device configured to receive multimedia content from the stream server 14 via the IP-based network 22. The network communication device 16 is capable of receiving multimedia content in the form of IP data packets via the IP-based network 22 and decoding the received data packets into a form suitable for playback and/or display by the network communication device 16, e.g., using a built-in display and speaker system. For example, the network communication device 16 can be a wireless local area network (WLAN) device, a wireless mobile video device, a cellular telephone, a smart telephone, a personal digital assistant (PDA), a digital music player, a portable video player, a wireless handheld device, a digital camera, a mobile communication device, a laptop personal computer (PC), a notebook PC and a mobile computing device.

Referring now to FIG. 2, with continuing reference to FIG. 1, shown is a block diagram of the stream server 14 for transmitting multimedia content to the network communication device 16 using a burst transmission mode. As will be discussed in greater detail hereinbelow, the stream server 14 transmits multimedia content to the network communication device 16 using a burst transmission mode that allows the network communication device 16 to receive such multimedia content in a manner that reduces power consumption by the network communication device 16. The stream server 14 includes a controller or processor 32 that, in general, processes multimedia content received by the stream server 14. The stream server 14 also can include an optional content storage element 34 coupled to the controller 32. In addition to the content storage element 34, the stream server 14 can include at least one type of memory or memory unit (not shown) within the controller 32 and/or a storage unit or data storage unit coupled to the controller 32 for storing processing instructions and/or information received and/or created by the stream server 14.

The stream server 14 also can include one or more input and/or output interfaces 36, 38 for receiving and delivering multimedia content via one or more IP-based networks. For example, the controller 32 and other components in the stream server 14 can be coupled between a first or input interface 36 and a second or output interface 38. The first interface 36 can receive multimedia content, e.g., from the multimedia content source 12, via the content delivery network 18. The first interface 36 can forward received information to the content storage element 34. The second interface 38 can transmit multimedia content received and/or stored by the stream server 14 to the network communication device 16, e.g., via the IP-based network 22. Also, because IP-based networks generally are bi-directional, the second interface 38 also can receive content and other information from the IP-based network 22, e.g., information from one or more network communication devices 16. It should be understood that one or more of the interfaces 36, 38 can be a single input/output interface coupled to the controller 32. Also, it should be understood that one or more of the interfaces 36, 38 can be an interface configured to support more than one connection from more than one network device.

The controller 32 is the central control point within the stream server 14 responsible for the receipt, control and transmission of multimedia content received by the stream server 14. The controller 32 also provides the appropriate decision-making to support such control of multimedia content delivered to and transferred from the stream server 14. The controller 32 is coupled to the storage element 34 and the various interfaces 36, 38. The controller 32 also can be coupled directly to the content delivery network 18 and/or the IP-based network 22. The controller 32 communicates with the network communication device 16 via the IP-based network 22.

The controller 32 and the interfaces 36, 38 are configured to provide any protocol interworking between the other components of the stream server 14 and the other components within the system 10. Since all content distribution systems are not the same, the controller 32 is configured to support the protocols of the particular system that is providing the content. Such protocol support functionality includes the identification of each of the content streams and corresponding protocol support required by the distribution system. Each distribution system will use a defined set of protocols.

For example, depending on the form or format of the multimedia content received by the stream server 14, the controller 32 and/or the interfaces 36, 38 may have to transcode such multimedia content for compatibility with the network communication device 16 before transmitting such multimedia content to the network communication device 16. For example, the stream server 14 may be part of an MPEG-2 set-top box with PVR functionality, and the network communication device 16 may be a cellular telephone with H.264 video decompression capability. In such case, the stream server 14 typically will have to transcode multimedia content received in MPEG-2 format to an H.264 or similar format.

The stream server 14 includes a burst mode transmission module 42 coupled to and/or contained within the controller 32 or other suitable component within the stream server 14. The burst mode transmission module 42 configures the received multimedia content appropriately for transmission by the stream server 14 using a burst transmission mode. As part of configuring the multimedia content appropriately for burst transmission mode, the burst mode transmission module 42 can generate and incorporate various control information into portions of the multimedia content, as will be discussed in greater detail hereinbelow.

One or more of the controller 32, the storage element 34 and the interfaces 36, 38 can be comprised partially or completely of any suitable structure or arrangement, e.g., one or more integrated circuits. Also, it should be understood that the stream server 14 includes other components, hardware and software (not shown) that are used for the operation of other features and functions of the stream server 14 not specifically described herein.

The stream server 14 can be partially or completely configured in the form of hardware circuitry and/or other hardware components within a larger device or group of components. Alternatively, the stream server 14 can be partially or completely configured in the form of software, e.g., as processing instructions and/or one or more sets of logic or computer code. In such configuration, the logic or processing instructions typically are stored in a data storage device, e.g., the content storage element 34 or other suitable data storage device (not shown). The data storage device typically is coupled to a processor or controller, e.g., the controller 32. The controller accesses the necessary instructions from the data storage element and executes the instructions or transfers the instructions to the appropriate location within the stream server 14.

According to the multimedia content delivery methods described herein, the stream server 14 is configured to transmit multimedia content received thereby to a network communication device using a burst transmission mode, rather than transmitting the multimedia content in a conventional manner, i.e., at a fixed packet rate. The stream server 14 uses a burst transmission mode to time-slice the packet stream delivered to the network communication device. As will be described hereinbelow, delivering multimedia content to network communication devices using a burst transmission mode reduces power consumption and therefore battery drain of the network communication device receiving the multimedia content.

As discussed hereinabove, in DVB-H networks, available specifications describe a time-slicing method used in DVB-H networks to reduce the average power consumption of the DVB-H terminal device, e.g., the DVB-H mobile communication device receiving the multimedia content. However, within DVB-H networks, multimedia content is broadcast using an MPEG-2 based transport medium. Such transport medium does not address the transmission or delivery of streaming multimedia content to network communication devices via IP-based networks, including wireless IP-based networks. For example, such network communication devices include wireless WLAN devices and other devices configured in accordance with one or more 802.11 WLAN communication specifications.

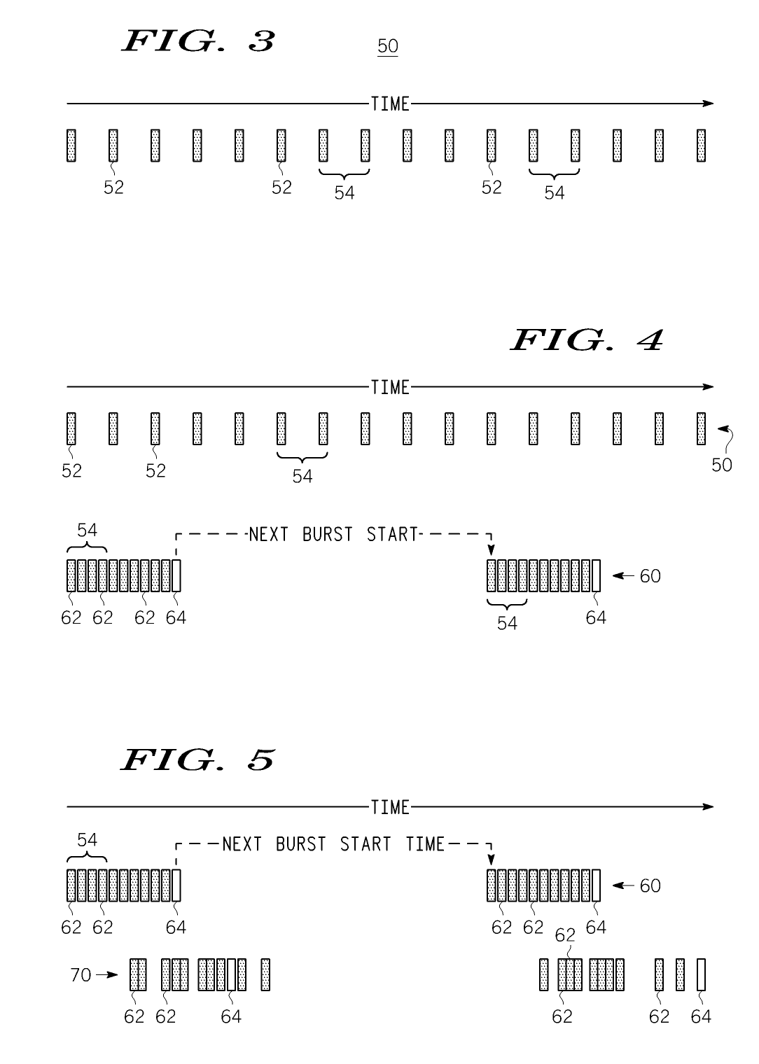

Referring now to FIG. 3, shown is a block diagram of a conventional, non-burst mode stream 50 of multimedia content. Such content stream is output from a conventional stream server, e.g., broadcast within a communications network to one or more communication devices. The conventional non-burst multimedia content stream 50 includes a plurality of data packets 52 transmitted at a fixed packet rate. That is, each data packet 52 is sent after a fixed time interval 54 has occurred since the transmission of the previous data packet, and the same time interval occurs before the transmission of the next data packet. Therefore, a single data packet is transmitted in each one of a given number of time frames or windows. To receive all data packets, a communication device must be in an active data-receiving mode throughout the entire period of data packet transmission. The content stream typically is described in terms of bit rate, e.g., in units of kilobits per second (kbps).

Referring now to FIG. 4, shown is a block diagram of the output 60 of a stream server device, such as a set-top box, configured to deliver multimedia content according to a burst transmission mode. For reference purposes, the stream server output is shown compared to the non-burst multimedia content stream 50 of FIG. 3. The burst transmission mode transmits the multimedia content as a plurality of time-sliced data bursts each having a transmission rate or bandwidth greater than the transmission rate or bandwidth of data transmitted in the non-burst transmission mode.

Burst transmission mode can be characterized in terms of burst rate (e.g., kilobits per second) and duty cycle. Duty cycle generally is the proportion of time during which the burst transmission mode is used. For example, within a given time frame, to transmit the same amount of data as a fixed packet rate transmission stream having a transmission rate of × kbps, a burst transmission mode with a 10× kbps burst rate will transmit the same amount of data in only 10% of the time (i.e., a 10% duty cycle).

In FIG. 4, compared to the × kbps non-burst transmission mode 50, a 4× kbps (25% duty cycle) burst transmission mode 60 generally is shown. Therefore, for each time frame interval 54, in which one non-burst transmission mode data packet is transmitted, 4 burst transmission mode data packets 62 are transmitted. Accordingly, the time-sliced data bursts of the burst transmission mode occur only 25% of the time.

Between the time-sliced data bursts, data is not transmitted. Therefore, as will be discussed in greater detail hereinbelow, the network communication device receiving the data bursts does not have to be active during the time-sliced data bursts, thus conserving battery power by reducing battery power consumption. Also, between the time-sliced data bursts, the stream server can transmit other information to other network devices.

A portion of the time-sliced data burst can include various control information. For example, a marker or other control information identifying the last data packet within the time-sliced data burst can be included in the data burst. Within IP-based networks, multimedia content often is transmitted according to the Real-time Transport Protocol (RTP), which defines a standardized packet format for delivering audio and video over the Internet. According to RTP, a data stream includes a header (RTP header), which includes various control information and other information. According to the methods, systems and devices described herein, the RTP header can include an indicator that denotes the last data packet of a data burst.

Other control information that can be included as part of the time-sliced data burst can include information indicating the transmission time for the next time-sliced data burst. Alternatively, the transmission time for the next time-sliced data burst can be advertised or transmitted by the stream server separate or independent from the time-sliced data bursts. Such control information allows variable burst durations of time-sliced data bursts to be used. Also, the time between time-sliced data bursts can vary. Therefore, although the time-sliced data bursts can be transmitted periodically, they do not have to be transmitted in such manner, i.e., data burst transmission can be aperiodic. Such dynamic implementation of time-sliced data bursts is particularly useful in transmitting variable bit rate (VBR) video content.

Although the stream server is configured to transmit time-sliced data bursts to network communication devices via IP-based networks in a controlled and determined manner, the receipt of the data bursts by the network communication device may differ from their transmission. For example, network jitter, packet re-ordering and other factors will impact how the network communication device receives the time-sliced data bursts from the stream server.

Referring now to FIG. 5, shown is a block diagram of the input 70 to a network communication device, such as a WLAN device, according to a burst transmission mode. The input 70 to the network communication device is shown compared to the stream server burst transmission mode output 60 of FIG. 4. As shown, each of the two time-sliced data bursts transmitted by the stream server have spread by the time they are received by the network communication device.

A data burst can be spread by the network, e.g., as a result of one or more inherent features of the particular IP-based network in use. As a result of the spreading of the data burst, the amount of time it takes for the network communication device to receive all of the data packets of each data burst increases. Thus, the network communication device must remain in an active data-receiving mode longer, thereby increasing battery usage. However, as shown, there still are relatively significant periods of time between data bursts, i.e., in which data is not transmitted, and in which the network communication device does not have to remain in an active data-receiving mode.

By using an end-of-packet marker to denote the last packet of a data burst, e.g., as discussed hereinabove, the network communication device is better able to determine if and when all packets of a given data burst been received. Once the last data packet within a data burst has been received, the network communication device can go into “sleep” mode for an amount of time determined by the transmission time of the next data burst, which, as discussed hereinabove, can be part of the control information included in the data burst. For example, the network communication device can set a timer based on the time of the next data burst and configure itself to go into a “sleep” mode to reduce battery power consumption. The network communication device does not receive data during the time the device is in “sleep” mode.

If for some reason the network communication device does not receive an end-of-packet marker for a given data burst, the network communication device can be configured to timeout after some time interval. In such case, the network communication device assumes packet loss has occurred. The network communication device then can transition to its “sleep” mode as a result of the timeout. However, if the control information is not received by the network communication device, the network communication device can be configured to remain in an active data-receiving mode until the next data burst is received.

Although a dedicated control packet 64 is shown, the stream server can be configured to include the burst timing information and other control information in each data packet or in more than one data packet to guarantee that the network communication device receives the start time of the next data burst, even if the network communication device has yet to receive all data packets of the current data burst. If data is being transmitted using the RTP, the burst timing information and other control information can be transmitted as an RTP header extension, e.g., which could contain a time value based on the same clock reference as the timestamp conveyed in the RTP header.

Jitter can adversely affect a network communication device's ability to efficiently transition between a sleep mode and an active data-receiving mode. If the network communication device goes into an active data-receiving mode too soon, unnecessary battery drain will result. If the network communication device goes into an active data-receiving mode too late, the network or network access point already may have discarded data packets intended for the network communication device.

Although wireless network access points and “stations” compliant with the 802.11e specification support device-triggered transmission of buffered data packets, the storage capacity is implementation-dependent and also depends on the number of stations. Other wireless network implementations may discard packets if the network communication device is not present (i.e., not in an active data-receiving mode) when the data packets arrive. Therefore, the network communication device should compute the relative network transit time for consecutive data packets by comparing source timestamps with actual arrival times. Based on these computations, the network communication device could continuously estimate the worst-case network jitter and adjust its sleep mode schedule accordingly. Alternatively, the network communication device can be remotely programmed with a specific “pre-delay” so that the network communication device transitions from the sleep mode to the active data-receiving mode early enough to receive the next data burst.

As discussed hereinabove, the IP-based network 22 typically is a bi-directional network, with the capability of unicasting unique data streams to individual network communication devices within the IP-based network 22. Also, in addition to the content streams unicast from the IP-based network 22 to the network communication device 16, data traffic generated by the network communication device 16 can be transmitted back to the IP-based network 22. Therefore, each network communication device 16 can receive a unique content stream from the stream server 14, and can communicate to the stream server 14 the specific manner in which the transmission bursts can be received by the particular network communication device 16.

For example, each network communication device 16 can transmit the desired frequency and/or bandwidth of the transmission bursts that the device wishes to receive, based on the particular attributes the device possesses. In this manner, for example, a particular network communication device 16 can request less frequent, higher bandwidth bursts for the same amount of content than another network communication device that may have different capacity and/or processing capabilities. That is, the particular network communication device (and the intervening network) may have the capacity and performance capabilities to tolerate higher bandwidth bursts. Accordingly, such devices can have longer sleep mode periods and thus less battery drain. Also, such information even can be transmitted on-the-fly, i.e., in real time, depending on network communication device and/or network conditions.

The transmission burst management just described can be performed dynamically, e.g., as the particular network communication device experiences performance impairments and improvements. Also, the stream server 14 can manage its time-slicing behavior on a per-stream basis. Alternatively, if network conditions dictate, the stream server 14 can multicast a single time-sliced content stream to several network communication devices 16. In such case, each network communication device can report its desired time-slice configuration and the stream server can establish the transmission burst settings that satisfies all or a relatively large percentage of the network communication devices.

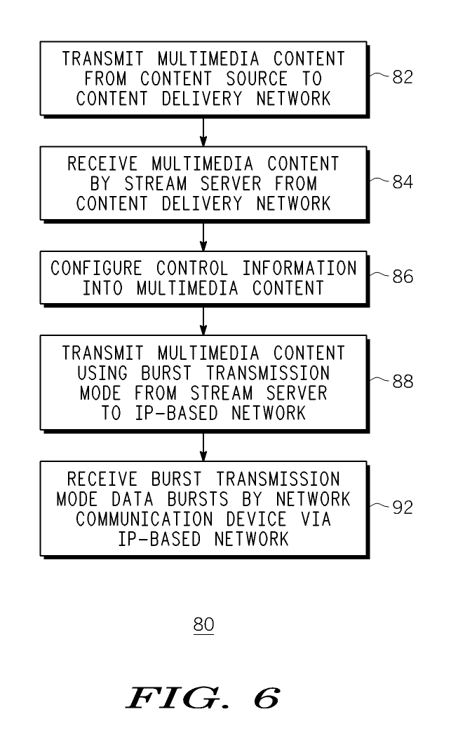

Referring now to FIG. 6, shown is a block diagram of a method 80 for transmitting multimedia content, using a burst transmission mode, to a network communication device within an IP-based network. The method 80 includes a step 82 of transmitting multimedia content from the multimedia content source or provider 12 to the content delivery network 18. As discussed hereinabove, the multimedia content provider 12 transmits multimedia content in any suitable format, such as MPEG 2 or MPEG 4, to the content delivery network 18. The content delivery network 18, which can be an IP-based network or other suitable network, is coupled to the multimedia content provider 12 via any suitable connection or connections, such as via a Hybrid Fiber Coaxial (HFC) cable system.

The method 80 also includes a step 84 of the stream server 14 receiving multimedia content from the multimedia content provider 12 via the content delivery network 18. The stream server is coupled to the content delivery network 18 in an appropriate manner to receive multimedia content transmitted from the multimedia content provider 12 to the content delivery network 18. The stream server 14 receives the multimedia content from the content delivery network 18 in a suitable format, e.g., MPEG 2 or MPEG 4 data packets.

The stream server 14 can buffer or store at least a portion of the received multimedia content, e.g., within the controller 32, the storage element 34 and/or the burst mode transmission module 42. As discussed hereinabove, the stream server 14 includes one or more suitable storage elements, such as the storage element 34 and the burst mode transmission module 42, suitable to buffer all or a portion of the multimedia content received by the stream server 14. The storage of the received multimedia content can be performed in anticipation of the transmission of multimedia content from the stream server 14 to the network communication device 16 using a burst transmission mode.

The method 80 also includes a step 86 of the stream server 14 configuring control information into the multimedia content received from the content delivery network 18. As discussed hereinabove, the burst mode transmission module 42 is configured to generate and incorporate various control information into at least a portion of the data packets that will be part of time-sliced data bursts transmitted by the stream server 14 to one or more network communication devices 16.

For example, the burst mode transmission module 42 can generate markers and/or other control information identifying the last data packet within time-sliced data bursts and/or the transmission time of future time-sliced data bursts. Such information can be part of a dedicated control packet, e.g., the control packet 64 shown in FIG. 4. Alternatively, the burst mode transmission module 42 can incorporate such information into existing headers, such as RTP headers and/or header extensions.

The method 80 also includes a step 88 of transmitting multimedia content to the wireless IP-based network 22 using a burst transmission mode. As discussed hereinabove, the stream server 14 is configured to transmit multimedia content to the wireless IP-based network 22 as a plurality of time-sliced data bursts, each including a plurality of data packets. The burst rate, duty cycle and other burst transmission mode parameters can vary according to several factors, including the type of multimedia content being transmitted, the capacity and storage ability of the stream server 14 (including the burst transmission module 42), and the data transmission rate of the stream server 14. Such burst transmission mode parameters also can vary depending on various information transmitted to the stream server 14 by one or more of the network communication devices 16, as discussed hereinabove.

The method 80 also includes a step 92 of the network communication device 16 receiving burst transmission mode data bursts from the stream server 14 via the IP-based network 22. As discussed hereinabove, the network communication device 16 is configured to receive multimedia content transmitted in burst transmission mode. The network communication device 16 also is configured to read and interpret various control information that may be incorporated into the data packets themselves and/or into packet headers and header extensions, as discussed hereinabove. Also, as discussed hereinabove, the receipt of the data bursts by the network communication device may differ from the transmission of the data bursts from the stream server, e.g., due to network jitter, packet re-ordering and other factors. Moreover, the manner in which data bursts are transmitted and/or received by the network communication device 16 can depend on various information about the network communication device 16 transmitted thereby to the stream server 14 via the IP-based network 22.

The method shown in FIG. 6 may be implemented in a general, multi-purpose or single purpose processor. Such a processor will execute instructions, either at the assembly, compiled or machine-level, to perform that process. Those instructions can be written by one of ordinary skill in the art following the description of FIG. 6 and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

It will be apparent to those skilled in the art that many changes and substitutions can be made to the content delivery methods herein described without departing from the spirit and scope of the invention as defined by the appended claims and their full scope of equivalents.

1. A method for transmitting multimedia content to at least one network communication device via an Internet Protocol (IP) based network, comprising the steps of:
receiving by a multimedia content processing device multimedia content from a multimedia content source; and
transmitting by the multimedia content processing device at least a portion of the multimedia content received thereby to the at least one network communication device via the IP-based network,
wherein the multimedia content processing device is configured to transmit multimedia content via the IP-based network to the network communication device in a burst transmission mode and a non-burst transmission mode, wherein the burst transmission mode transmits multimedia content as a plurality of time-sliced data bursts each having a transmission bandwidth greater than the transmission bandwidth of data transmitted in the non-burst transmission mode.

2. The method as recited in claim 1, wherein at least a portion of the time-sliced data burst includes at least one marker identifying the last data packet within the time-sliced data burst.

3. The method as recited in claim 1, wherein the transmitting step includes advertising when the next time-sliced data burst will be transmitted.

4. The method as recited in claim 1, wherein the transmitting step includes transmitting the plurality of time-sliced data bursts periodically.

5. The method as recited in claim 1, wherein at least two of the time-sliced data bursts have different burst durations.

6. The method as recited in claim 1, wherein the time-sliced data burst transmitted to the network communication device includes data burst transmission information including at least one of identifying the last data packet within the time-sliced data burst and indicating when the next time-sliced data burst will be transmitted, and wherein the network communication device is configured to operate in a power-conserving sleep mode based on the data burst transmission information.

7. The method as recited in claim 1, wherein the multimedia content processing device is selected from the group consisting of a stream server, a network session controller, a signal converter box, a signal decoder box, a wireless network server, a wireless home media server, a digital video server, a residential gateway, and a computer.

8. The method as recited in claim 1, wherein the network communication device is selected from the group consisting of a wireless local area network (WLAN) device, a wireless mobile video device, a cellular telephone, a smart telephone, a personal digital assistant (PDA), a digital music player, a portable video player, a wireless handheld device, a digital camera, a mobile communication device, a laptop personal computer (PC), a notebook PC and a mobile computing device.

9. A multimedia content processing device for transmitting multimedia content to at least one network communication device via an Internet Protocol (IP) based network, comprising:
a controller configured to receive multimedia content;
a memory element coupled to the controller for storing at least a portion of the multimedia content received by the controller;
a burst mode transmission module coupled to the controller,
wherein the burst mode transmission module is configured to transmit multimedia content via the IP-based network to the network communication device in a burst transmission mode and a non-burst transmission mode, wherein the burst transmission mode transmits multimedia content as a plurality of time-sliced data bursts each having a transmission bandwidth greater than the transmission bandwidth of data transmitted in the non-burst transmission mode.

10. The device as recited in claim 9, wherein the network communication device includes an active mode in which the network communication device can receive multimedia content and a power-conserving sleep mode in which the network communication device does not receive multimedia content, wherein the burst mode transmission module is configured to include control information in at least a portion of the multimedia content the multimedia content processing device transmits to the network communication device, and wherein the network communication device is configured to switch between the active mode and the power-conserving sleep mode based on the control information included in the multimedia content.

11. The device as recited in claim 9, wherein the multimedia content processing device is configured to receive information transmitted from at least one network communication device, wherein the information received by the multimedia content processing device from the network communication device includes information related to the ability of the network communication device to receive multimedia content in the burst transmission mode.

12. The device as recited in claim 9, wherein the burst transmission mode includes a burst rate and a duty cycle, and wherein the burst mode transmission module is configured to vary at least one of the burst rate and duty cycle of the burst transmission mode based on information received by the multimedia content processing device from the network communication device.

13. The device as recited in claim 9, wherein the burst mode transmission module is configured to include in at least a portion of the time-sliced data burst at least one of a marker identifying the last data packet within the time-sliced data burst and the number of packets within the time-sliced data burst.

14. The device as recited in claim 9, wherein the burst mode transmission module is configured to generate control information included in at least a portion of the time-sliced data bursts, wherein the control information includes the time the next time-sliced data burst will be transmitted.

15. The device as recited in claim 9, wherein the controller is configured to receive multimedia content in a first format that is not compatible with the network communication device, and configured to transcode the received multimedia content from the first format to a second format that is compatible with the network communication device.

16. The device as recited in claim 9, wherein the multimedia content processing device is configured to transmit a plurality of unicast streams of multimedia content to a corresponding plurality of network communication devices.

17. The device as recited in claim 9, wherein the controller is configured to transmit multimedia content according to the Real-time Transport Protocol.

18. The device as recited in claim 9, wherein the multimedia content processing device is selected from the group consisting of a stream server, a network session controller, a signal converter box, a signal decoder box, a wireless network server, a wireless home media server, a digital video server, a residential gateway, and a computer.

19. The device as recited in claim 9, wherein the network communication device is selected from the group consisting of a wireless local are network (WLAN) device, a wireless mobile video device, a cellular telephone, a smart telephone, a personal digital assistant (PDA), a digital music player, a portable video player, a wireless handheld device, a digital camera, a mobile communication device, a laptop personal computer (PC), a notebook PC and a mobile computing device.

20. A computer readable medium storing instructions that, when executed on a programmed processor, carry out a method for transmitting multimedia content to at least one network communication device via an Internet Protocol (IP) based network, comprising:
instructions for receiving by a multimedia content processing device multimedia content from a multimedia content source; and
instructions for transmitting by the multimedia content processing device at least a portion of the multimedia content received thereby to the at least one network communication device via the IP-based network,
wherein the multimedia content processing device is configured to transmit multimedia content via the IP-based network to the network communication device in a burst transmission mode and a non-burst transmission mode, wherein the burst transmission mode transmits multimedia content as a plurality of time-sliced data bursts each having a transmission bandwidth greater than the transmission bandwidth of data transmitted in the non-burst transmission mode.
